(19) United States
(12) Patent Application Publication
(10) Pub. No.: US 2026/0093256 A1
(43) Pub. Date: Apr. 2, 2026

(54) METHOD AND DEVICE FOR GENERATING DEPTH MAP

(71) Applicants: Hyundai Motor Company, Seoul (KR); Kia Corporation, Seoul (KR)

(72) Inventors: Sohee Kim, Hwaseong-si (KR); Sunkyung Kim, Hwaseong-si (KR)

(21) Appl. No.: 19/217,764

(22) Filed: May 23, 2025

(30) Foreign Application Priority Data
Sep. 30, 2024 (KR) 10-2024-0132601

(51) Int. Cl. G05D 1/246; G01S 17/89; G05D 101/15; G05D 105/80; G05D 109/10; G05D 111/10

(52) U.S. Cl. CPC G05D 1/246; G01S 17/89; G05D 2101/15; G05D 2105/87; G05D 2109/10; G05D 2111/17

(57) ABSTRACT

Disclosed is a depth map generation method and device. The method includes: acquiring an RGB color image via a monocular camera provided in a robot system; acquiring a three-dimensional point cloud via a light detection and ranging (LiDAR) sensor provided in the robot system; generating, from the three-dimensional point cloud, a sparse depth map including depth information for only some points in a given space; inputting the RGB color image and the sparse depth map into a pre-trained diffusion model; and generating, based on the diffusion model, a dense depth map including depth information for all points in the given space, in which the diffusion model is trained by introducing a loss function that reflects confidence, which is a numerical representation of confidence level in a prediction of the diffusion model.

### CROSS-REFERENCE TO RELATED APPLICATIONS

This application claims priority to and the benefit of Korean Patent Application No. 10-2024-0132601 filed in the Korean Intellectual Property Office on Sep. 30, 2024, the entire contents of which are incorporated herein by reference.

### TECHNICAL FIELD

The disclosure relates to a depth map generation method and device.

### BACKGROUND

Human-Robot Interaction (HRI) is a field of study that involves understanding, designing, and evaluating interactions between humans and robots. Key aspects of HRI include communication and interaction, design and aesthetics, safety and trust, social interaction, adaptability and learning, and the like. Especially in physical human-robot interactions, it is important that the robot behaves in a predictable and reliable manner, that the robot is aware of the environment and the human state and adapts its behavior accordingly, and depth estimation is essential to implement these aspects. A depth map is a representation of the depth information of an object or environment in three-dimensional space in the form of a two-dimensional image, where each pixel value in the depth map may represent the distance from a corresponding point. Depth maps may be used for 3D reconstruction, object detection and tracking, scene understanding, and robot navigation to help robots recognize their surrounding environments and move while avoiding obstacles, as well as in human-robot interaction.

### SUMMARY

The present disclosure attempts to provide a depth map generation method and device capable of acquiring a sparse depth map from data acquired by sensors of a robot and generating a sophisticated dense depth map based on the sparse depth map and a diffusion model.

An example embodiment of the present invention provides a method of generating a depth map, the method including: acquiring an RGB color image via a monocular camera provided in a robot system; acquiring a three-dimensional point cloud via a light detection and ranging (LiDAR) sensor provided in the robot system; generating, from the three-dimensional point cloud, a sparse depth map including depth information for only some points in a given space; inputting the RGB color image and the sparse depth map into a pre-trained diffusion model; and generating, based on the diffusion model, a dense depth map including depth information for all points in the given space, in which the diffusion model is trained by introducing a loss function that reflects confidence, which is a numerical representation of confidence level in a prediction of the diffusion model.

In some example embodiments, the method may further include training the diffusion model to predict the dense depth map when the noise and the sparse depth map are input, by using the noise and the sparse depth map as training data according to a predetermined setting.

In some example embodiments, the training of the diffusion model may include: reading the predetermined setting; when it is determined that the predetermined setting includes a first setting, normalizing a depth value of the sparse depth map to a value in a range of −1 to 1; setting one or more local regions in the sparse depth map; replacing, in the noise, a value of a location corresponding to the one or more local regions with a sparse depth value in the one or more local regions; and training the diffusion model based on the noise, in which the value of the location corresponding to the one or more local regions is replaced, and the sparse depth map in which the normalization has been performed.

In some example embodiment, the training of the diffusion model may include: reading the predetermined setting; when it is determined that the predetermined setting includes a second setting, normalizing a depth value of the sparse depth map used as the training data to a value in a range of −1 to 1; and training the diffusion model based on the noise and the sparse depth map on which the normalization has been performed.

In some example embodiments, the loss function may be determined by Equation 1 below:

$$L = Mean ( L \text{*)} , L ∈ R \qquad ( Equation 1 )$$

herein, L is a loss function, Mean( ) is a function that computes a mean, R is a set of real numbers, and L* is determined according to Equation 2 below:

$$L *= {C}_{dc} ⊙ \sqrt{{( GTDDM - PDDM )}^{2}} L * ∈ {R}^{D \times H \times W} \qquad ( Equation 2 )$$

herein, C_{dc} is the confidence, an operator ⊙ is a pixel wise dot product operator, and GTDDM (Ground Truth Dense Depth Map) is an actual true answer for the dense depth map, PDDM (Predicted Dense Depth Map) is a predicted value for the dense depth map, and R^{D×H×W} is a set of real numbers (wherein D is the number of channels of the dense depth map, H is a vertical length of the dense depth map, and W is a horizontal length of the dense depth map).

In some example embodiments, the confidence C_{dc} may be determined according to Equation 3 and Equation 4 below:

$${C}_{dc}^{*} = C + {C}_{e} \qquad ( Equation 3 )$$

$${C}_{dc} = \{ \begin{matrix}{C}_{dc}^{*} & ( if {C}_{dc}^{*} > 0 ) \\ 1 , & ( Otherwise )\end{matrix} \qquad ( Equation 4 )$$

herein, C is a difference between an output value and an answer in the diffusion model, and Cₑ is determined according to Equation 5 and Equation 6 below:

$${C}_{e} = C ⊙ E * \qquad ( Equation 5 )$$

$$E *= \{ \begin{matrix}w * E & ( if Sobel ( PDDM ) > γ , w > 1 ) \\ 0 , & ( Otherwise )\end{matrix} \qquad ( Equation 6 )$$

herein, E is an edge map acquired by passing through an edge detector, Sobel( ) is a function for detecting an edge intensity in the edge map, γ may be a predetermined reference value, and w is a predetermined weight.

In some example embodiments, the C may be determined according to Equation 7 and Equation 8 below:

$$C *= \sqrt{{( GTDDM - PDDM )}^{2}} , C * ∈ {R}^{D \times H \times W} \qquad ( Equation 7 )$$

$$C = \{ \begin{matrix}α & ( if C * > Mean ( C \text{*)} and GTDDM > 0 , α > 1 ) \\ 0 & ( Otherwise )\end{matrix} \qquad ( Equation 8 )$$

herein, α is a predetermined weight.

In some example embodiments, the loss function may be determined according to Equation 9 below:

$$L = Mean ( L \text{*)} , L ∈ R \qquad ( Equation 9 )$$

herein, L is the loss function, Mean( ) is the function that computes the mean, R is the set of real numbers, and L* is determined according to Equation 10 below:

$$L *= C \vert GTDDM - PDDM \vert , L * ∈ {R}^{D \times H \times W} \qquad ( Equation 10 )$$

herein, GTDDM is an actual true answer for the dense depth map, PDDM is a predicted value for the dense depth map, R^{D×H×W} is a set of real numbers (wherein D is a number of channels of the dense depth map, H is a vertical length of the dense depth map, W is a horizontal length of the dense depth map), and C may be determined according to Equation 11 and Equation 12 below:

$$C *= \vert GTDDM - PDDM \vert , C * ∈ {R}^{D \times H \times W} \qquad ( Equation 11 )$$

$$C = \{ \begin{matrix}α & ( if C * > Mean ( C \text{*)} and GTDDM > 0 , α > 1 ) \\ 0 & ( Otherwise )\end{matrix} \qquad ( Equation 12 )$$

herein, α is a predetermined weight.

In some example embodiments, the loss function may be determined according to Equation 13 below:

$$L = Mean ( L \text{*)} , L ∈ R \qquad ( Equation 13 )$$

herein, L is the loss function, Mean( ) is the function that computes a mean, R is the set of real numbers, and L* is determined according to Equation 14 below:

$${L}^{*} = C ⊙ \sqrt{{( GTDDM - PDDM )}^{2}} , {L}^{*} ∈ {R}^{D \times H \times W} \qquad ( Equation 14 )$$

herein, the operator ⊙ is a pixel wise dot product operator, GTDDM is an actual true answer for the dense depth map, PDDM is a predicted value for the dense depth map, R^{D×H×W} is a set of real numbers (wherein D is a number of channels of the dense depth map, H is a vertical length of the dense depth map, and W is a horizontal length of the dense depth map), and C is determined according to Equation 15 and Equation 16 below:

$${C}^{*} = \sqrt{{( GTDDM - PDDM )}^{2}} , {C}^{*} ∈ {R}^{D \times H \times W} \qquad ( Equation 15 )$$

$$C = \{ \begin{matrix}α & ( if {C}^{*} > Mean ( {C}^{*} ) and GTDDM > 0 , α > 1 ) \\ 0 & ( Otherwise )\end{matrix} \qquad ( Equation 16 )$$

herein, α is a predetermined weight.

In some example embodiments, the loss function may be determined according to Equation 17 below:

$$L = Mean ( {L}^{*} ) , L ∈ R \qquad ( Equation 17 )$$

herein, L is a loss function, Mean( ) is a function that computes a mean, R is a set of real numbers, and L* is determined according to Equation 18 below,

$${L}^{*} = {E}^{*} ⊙ \sqrt{{( GTDDM - PDDM )}^{2}} , {L}^{*} ∈ {R}^{D \times H \times W} \qquad ( Equation 18 )$$

herein, the operator ⊙ is a pixel wise dot product operator, GTDDM is an actual true answer for the dense depth map, PDDM is a predicted value for the dense depth map, R^{D×H×W} is a set of real numbers (wherein D is a number of channels of the dense depth map, H is a vertical length of the dense depth map, and W is a horizontal length of the dense depth map), and E* may be determined according to Equation 19 below:

$${E}^{*} = \{ \begin{matrix}w * E & ( if Sobel ( PDDM ) > γ , w > 1 ) \\ 0 , & ( Otherwise )\end{matrix} \qquad ( Equation 19 )$$

herein, E is an edge map acquired by passing the edge detector, Sobel( ) is a function that detects edge intensity in the edge map, γ is a predetermined reference value, and w is a predetermined weight.

Another example embodiment of the present invention provides a device for generating a depth map, which executes a program code loaded in one or more memory devices through one or more processors, in which wherein the program code is executed to acquire an RGB color image via a monocular camera provided in a robot system, acquire a three-dimensional point cloud via a light detection and ranging (LiDAR) sensor provided in the robot system, generate, from the three-dimensional point cloud, a sparse depth map including depth information for only some points in a given space, input the RGB color image and the sparse depth map into a pre-trained diffusion model, and generate, based on the diffusion model, a dense depth map including depth information for all points in the given space, in which the diffusion model is trained by introducing a loss function that reflects confidence, which is a numerical representation of confidence level in a prediction of the diffusion model.

In some example embodiments, the program code may be executed to further train the diffusion model to predict the dense depth map when the noise and the sparse depth map are input, by using the noise and the sparse depth map as training data according to a predetermined setting.

In some example embodiments, the training of the diffusion model may include: reading the predetermined setting; when it is determined that the predetermined setting includes a first setting, normalizing a depth value of the sparse depth map to a value in a range of −1 to 1; setting one or more local regions in the sparse depth map; replacing, in the noise, a value of a location corresponding to the one or more local regions with a sparse depth value in the one or more local regions; and training the diffusion model based on the noise, in which the value of the location corresponding to the one or more local regions is replaced, and the sparse depth map in which the normalization has been performed.

In some example embodiment, the training of the diffusion model may include: reading the predetermined setting; when it is determined that the predetermined setting includes a second setting, normalizing a depth value of the sparse depth map used as the training data to a value in a range of −1 to 1; and training the diffusion model based on the noise and the sparse depth map on which the normalization has been performed.

In some example embodiments, the loss function may be determined by Equation 1 below,

$$L = Mean ( {L}^{*} ) , L ∈ R \qquad ( Equation 1 )$$

herein, L is a loss function, Mean( ) is a function that computes a mean, R is a set of real numbers, and L* is determined according to Equation 2 below:

$${L}^{*} = {C}_{dc} ⊙ \sqrt{{( GTDDM - PDDM )}^{2}} , {L}^{*} ∈ {R}^{D \times H \times W} \qquad ( Equation 2 )$$

herein, C_{dc} is the confidence, an operator ⊙ is a pixel wise dot product operator, and GTDDM (Ground Truth Dense Depth Map) is an actual true answer for the dense depth map, PDDM (Predicted Dense Depth Map) is a predicted value for the dense depth map, and R^{D×H×W} is a set of real numbers (wherein D is the number of channels of the dense depth map, H is a vertical length of the dense depth map, and W is a horizontal length of the dense depth map).

In some example embodiments, the confidence C_{dc} may be determined according to Equation 3 and Equation 4 below:

$${C}_{dc}^{*} = C + {C}_{e} \qquad ( Equation 3 )$$

$${C}_{dc} = \{ \begin{matrix}{C}_{dc}^{*} , & ( if {C}_{dc}^{*} > 0 ) \\ 1 , & ( Otherwise )\end{matrix} \qquad ( Equation 4 )$$

herein, C is a difference between an output value and an answer in the diffusion model, and Cₑ is determined according to Equation 5 and Equation 6 below:

$${C}_{e} = C ⊙ {E}^{*} \qquad ( Equation 5 )$$

$${E}^{*} = \{ \begin{matrix}w * E & ( if Sobel ( PDDM ) > γ , w > 1 ) \\ 0 , & ( Otherwise )\end{matrix} \qquad ( Equation 6 )$$

herein, E is an edge map acquired by passing through an edge detector, Sobel( ) is a function for detecting an edge intensity in the edge map, γ may be a predetermined reference value, and w is a predetermined weight.

In some example embodiments, the C may be determined according to Equation 7 and Equation 8 below:

$${C}^{*} = \sqrt{{( GTDDM - PDDM )}^{2}} , {C}^{*} ∈ {R}^{D \times H \times W} \qquad ( Equation 7 )$$

$$C = \{ \begin{matrix}α & ( if {C}^{*} > Mean ( {C}^{*} ) and GTDDM > 0 , α > 1 ) \\ 0 & ( Otherwise )\end{matrix} \qquad ( Equation 8 )$$

herein, α is a predetermined weight.

In some example embodiments, the loss function may be determined according to Equation 9 below:

$$L = Mean ( {L}^{*} ) , L ∈ R \qquad ( Equation 9 )$$

herein, L is the loss function, Mean( ) is the function that computes the mean, R is the set of real numbers, and L* is determined according to Equation 10 below:

$${L}^{*} = C \vert GTDDM - PDDM \vert , {L}^{*} ∈ {R}^{D \times H \times W} \qquad ( Equation 10 )$$

herein, GTDDM is an actual true answer for the dense depth map, PDDM is a predicted value for the dense depth map, R^{D×H×W} is a set of real numbers (wherein D is a number of channels of the dense depth map, H is a vertical length of the dense depth map, W is a horizontal length of the dense depth map), and C may be determined according to Equation 11 and Equation 12 below:

$${C}^{*} = \vert GTDDM - PDDM \vert , {C}^{*} ∈ {R}^{D \times H \times W} \qquad ( Equation 11 )$$

$$C = \{ \begin{matrix}α & ( if {C}^{*} > Mean ( {C}^{*} ) and GTDDM > 0 , α > 1 ) \\ 0 & ( Otherwise )\end{matrix} \qquad ( Equation 12 )$$

herein, α is a predetermined weight.

In some example embodiments, the loss function may be determined according to Equation 13 below:

L=Mean(L*),L∈R (Equation 13)

herein, L is the loss function, Mean( ) is the function that computes a mean, R is the set of real numbers, and L* is determined according to Equation 14 below:

$${L}^{*} = C ⊙ \sqrt{{( GTDDM - PDDM )}^{2}} , {L}^{*} ∈ {R}^{D \times H \times W} \qquad ( Equation 14 )$$

herein, the operator ⊙ is a pixel wise dot product operator, GTDDM is an actual true answer for the dense depth map, PDDM is a predicted value for the dense depth map, R^{D×H×W} is a set of real numbers (wherein D is a number of channels of the dense depth map, H is a vertical length of the dense depth map, and W is a horizontal length of the dense depth map), and C is determined according to Equation 15 and Equation 16 below:

$${C}^{*} = \sqrt{{( GTDDM - PDDM )}^{2}} , {C}^{*} ∈ {R}^{D \times H \times W} \qquad ( Equation 15 )$$

$$C = \{ \begin{matrix}α & ( if {C}^{*} > Mean ( {C}^{*} ) and GTDDM > 0 , α > 1 ) \\ 0 & ( Otherwise )\end{matrix} \qquad ( Equation 16 )$$

herein, α is a predetermined weight.

In some example embodiments, the loss function may be determined according to Equation 17 below:

$$L = Mean ( {L}^{*} ) , L ∈ R \qquad ( Equation 17 )$$

herein, L is a loss function, Mean( ) is a function that computes a mean, R is a set of real numbers, and L* is determined according to Equation 18 below,

$${L}^{*} = {E}^{*} ⊙ \sqrt{{( GTDDM - PDDM )}^{2}} , {L}^{*} ∈ {R}^{D \times H \times W} \qquad ( Equation 18 )$$

herein, the operator ⊙ is a pixel wise dot product operator, GTDDM is an actual true answer for the dense depth map, PDDM is a predicted value for the dense depth map, R^{D×H×W} is a set of real numbers (wherein D is a number of channels of the dense depth map, H is a vertical length of the dense depth map, and W is a horizontal length of the dense depth map), and E* may be determined according to Equation 19 below:

$${E}^{*} = \{ \begin{matrix}w * E ( if Sobel ( PDDM ) > γ , w > 1 ) \\ 0 , ( Otherwise )\end{matrix} \qquad ( Equation 19 )$$

herein, E is an edge map acquired by passing the edge detector, Sobel( ) is a function that detects edge intensity in the edge map, γ is a predetermined reference value, and w is a predetermined weight.

### BRIEF DESCRIPTION OF THE DRAWINGS

FIG. 1 is a block diagram for illustrating a depth map generation device according to an example embodiment.

FIG. 2 is a flow diagram for illustrating a depth map generation method according to an example embodiment.

FIG. 3 is a flow diagram for illustrating the depth map generation method according to the example embodiment.

FIG. 4 is a diagram for illustrating an example of an operation of the depth map generation device according to the example embodiment.

FIG. 5 is a diagram for illustrating an example of an operation of the depth map generation device according to the example embodiment.

FIG. 6 is a diagram for illustrating an example of an operation of the depth map generation device according to the example embodiment.

FIG. 7 and FIG. 8 are diagrams for illustrating an example of an operation of the depth map generation device according to the example embodiment.

FIG. 9A, FIG. 9B, FIG. 9C and FIG. 9D are diagrams illustrating example dense depth maps generated according to the example embodiments.

FIG. 10 is a diagram for illustrating a computing device according to an example embodiment.

### DETAILED DESCRIPTION OF ILLUSTRATIVE EMBODIMENTS

Hereinafter, the present invention will be described more fully hereinafter with reference to the accompanying drawings, in which example embodiments of the invention are shown. As those skilled in the art would realize, the described example embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and the claims, unless explicitly described to the contrary, the word “comprise”, and variations such as “comprises” or “comprising”, will be understood to imply the inclusion of stated elements but not the exclusion of any other elements. Terms including an ordinary number, such as first and second, are used for describing various components, but the components are not limited by the terms. The terms are used only to discriminate one component from another component.

Terms such as “part,” “unit,” “module,” and the like in the specification may refer to a unit capable of performing at least one function or operation described herein, which may be implemented in hardware or circuitry, software, or a combination of hardware or circuitry and software. In addition, at least some of the configurations or functions of a depth map generation device and method according to the example embodiments described below may be implemented as programs or software, and the programs or software may be stored on a computer-readable medium.

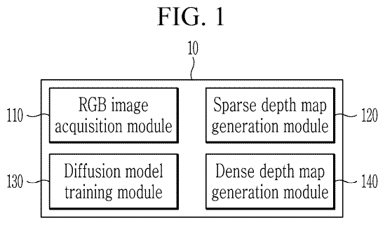

FIG. 1 is a block diagram for illustrating a depth map generation device according to an example embodiment.

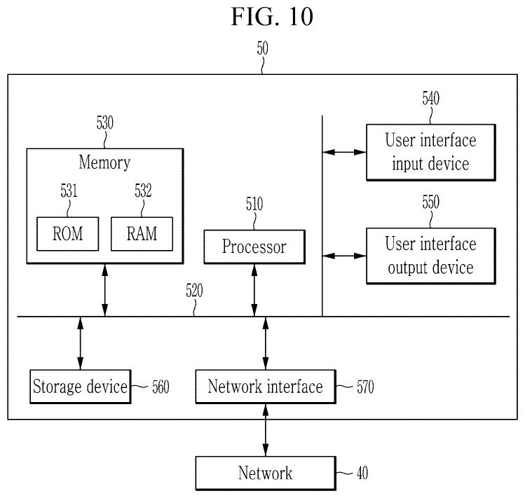

Referring to FIG. 1, a depth map generation device 10 according to an example embodiment, may execute program code or instructions loaded into one or more memory devices via one or more processors. For example, the depth map generation device 10 may be implemented as a computing device 50, such as the one described later with reference to FIG. 10. In this case, one or more processors may correspond to a processor 510 of the computing device 50, and one or more memory devices may correspond to a memory 520 of the computing device 50. Program code, or instructions, may be executed by the one or more processors to perform functions for generating a sparse depth map and a dense depth map from data acquired via sensors of the robot. In this specification, the term “module” is used to logically distinguish between these functions performed by the program code.

The depth map generation device 10 according to the example embodiment may execute a program code including an RGB image acquisition module 110, a sparse depth map generation module 120, a diffusion model training module 130, and a dense depth map generation module 140.

The RGB image acquisition module 110 may acquire RGB color images through a monocular camera provided in a robot system. A monocular camera may capture images through a single lens. Because monocular cameras are cost-effective, simple to configure, and small, monocular cameras may be widely used by robots to recognize their surroundings and identify or track objects. However, monocular cameras typically do not provide depth information directly.

The sparse depth map generation module 120 may acquire a three-dimensional point cloud via a light detection and ranging (LiDAR) sensor provided on the robot system and generate a sparse depth map from the three-dimensional point cloud, which includes depth information for only some points in a given space.

A LiDAR sensor may measure distances to their surrounding environments by using light. Specifically, the LiDAR sensor may calculate the distance to the target by firing a laser pulse at a target and measuring the time it takes for the reflected pulse to return, and generate a three-dimensional map of the surrounding environment based on the information. LiDAR sensors may measure distances with high precision and generate detailed 3D images, so that the LiDAR Sensor is capable of precisely understanding the environment, and may be used in low-light conditions or in inclement weather.

A three-dimensional point cloud acquired by a LiDAR sensor is a set of points in space, where each point may correspond to a specific location in the real physical environment. In some example embodiments, the three-dimensional point cloud data may include information, such as the location (e.g., x, y, z coordinates), reflection intensity, and color (e.g., RGB value) of the point.

A sparse depth map may not include all points, but include only those points that are selected based on certain predetermined criteria. A few selected points in a three-dimensional point cloud may be projected onto a two-dimensional plane to generate a two-dimensional image, and each pixel in the two-dimensional image may be assigned a depth value (e.g., z coordinate) of the corresponding three-dimensional point. Regions that are not projected onto the two-dimensional plane may be left with no depth value.

The diffusion model training module 130 may train a diffusion model by using a sparse depth map generated by the sparse depth map generation module 120 as training data according to predetermined settings.

A diffusion model is an algorithm designed by analogizing the process of generating data to the diffusion process in physics, and may include a diffusion process that gradually corrupts real data with noise first, and an inverse process or inverse diffusion process that restores the original data from the noise. The diffusion process is accomplished through a number of sub-steps, and in each of the sub-steps, noise is added to the data, and finally the data may become a complete noise state. In the inverse process, the diffusion model learns to restore the noise back to the original data, and may finally remove the noise and recover the original features of the data.

For example, between an original image xₒ and an image x_{T} that follows a complete random gaussian, the diffusion process q(xₜ|xₜ₋₁) which processes from an intermediate image xₜ₋₁ to an intermediate image xₜ may be the application of a sequential Gaussian Markov chain starting from the original image xₒ, through intermediate image xₜ₋₁ and intermediate image xₜ, to the image x_{T}. Further, the purpose of the diffusion model is to learn the inverse process p(xₜ₋₁|xₜ) starting from image x_{T} and returning to the original image xₒ. In the diffusion model, the goal of the diffusion model is to reduce the distance between p(xₜ₋₁|xₜ), which goes from the intermediate image xₜ to the intermediate image xₜ₋₁, and q(xₜ|xₜ₋₁), which goes from the intermediate image xₜ₋₁ to the intermediate image xₜ. After the training of the diffusion model is complete, a realistic image xₒ starting from the image X_{T} that follows a completely random Gaussian may be generated through the sequential sampling. In some example embodiments, the difference in the distance between p(xₜ₋₁|xₜ) and q(xₜ|xₜ₋₁) may be measured by using the Kullback-Leibler divergence (KL-Divergence), and minimizing the distance between p(xₜ₋₁|xₜ) and q(xₜ|xₜ₋₁) may be to minimize the Kullback-Leibler divergence.

The dense depth map generation module 140 may generate a dense depth map that includes depth information for all points in a given space by inputting the RGB color image acquired from the RGB image acquisition module 110 and the sparse depth map generated by the sparse depth map generation module 120 into a pre-trained diffusion model.

In some example embodiments, the diffusion model training module 130 may train a diffusion model to predict a dense depth map when a noise and a sparse depth map are input by using the noise and the sparse depth map as training data according to a predetermined setting. Specifically, the diffusion model training module 130 may read a predetermined setting and, when it is determined that the predetermined setting includes a first setting, the diffusion model training module 130 may normalize the depth value of the sparse depth map used as training data to a value in the range of −1 to 1. For example, the distribution of actual depth values in the sparse depth map may be represented by values between 0 and 80. Since the diffusion model is trained by applying noise with values between −1 and 1, when depth values between 0 and 80 are input into the diffusion model directly, the training may not proceed properly due to the difference in the range of values. To avoid this problem, the diffusion model training module 130 may normalize the depth values of the sparse depth map used as the training data to values in the range of −1 to 1, and then input the normalized values into the diffusion model to perform training.

The diffusion model training module 130 may generate noise that has the same size horizontally and vertically as the sparse depth map. In some example embodiments, the diffusion model training module 130 may generate Gaussian noise that includes random values that follow a Gaussian distribution. The diffusion model training module 130 may then manipulate the noise by replacing the value of the noise with another value. Specifically, the diffusion model training module 130 may set one or more local regions in the sparse depth map. Pixels in the set local regions have sparse depth values, where the sparse depth values may be treated as a kind of ground truth data, i.e., dense depth data. The diffusion model training module 130 may replace the value of the location corresponding to the one or more local regions in the noise with the sparse depth value of the one or more local region. Further, the diffusion model training module 130 may train a diffusion model based on the noise in which the value of the location corresponding to the one or more local region has been replaced, and the sparse depth map in which normalization has been performed. In other words, the diffusion model training module 130 may manipulate a noise value for a specific pixel in the noise so that a more accurate depth value is predicted at the corresponding location.

A diffusion model may be a model that finds the distribution of data on a pixel-by-pixel basis in random data. By setting a sparse depth value in the noise, a starting point of a corresponding pixel location starts with a corresponding sparse depth value, and the corresponding pixel location may have a distribution with a narrower deviation. On the other hand, since depth information is continuous, a depth value of a specific pixel is likely to be similar to the depth values of neighboring pixels. Since the convolution operation takes this neighborhood information into account, more accurate depth estimation may be possible through the influence of the pixels in which the sparse depth values are set in the noise on the surroundings.

In some example embodiments, the diffusion model training module 130 may read the predetermined setting and, when it is determined that the predetermined setting includes a second setting that is different from a first setting, the diffusion model training module 130 may normalize the depth values in the sparse depth map used as training data to values in the range of −1 to 1. Next, the diffusion model training module 130 may generate a noise having the same sizes horizontally and vertically as the sparse depth map. In some example embodiments, the diffusion model training module 130 may generate Gaussian noise that includes random values that follow a Gaussian distribution. Further, the diffusion model training module 130 may train the diffusion model based on the generated noise and the sparse depth map on which the normalization has been performed. In other words, the diffusion model training module 130 may ensure that the depth values are predicted in an efficient manner that may save computing resources without manipulating the noise values for specific pixels in the noise.

In some example embodiments, the diffusion model may be trained by introducing a loss function that reflects a confidence, which is a numerical representation of the confidence for the diffusion model's prediction. Herein, the confidence is a measure of how confident the diffusion model is in making a specific prediction, and for example, the case where the confidence is expressed as a probability between 0 and 1, with values closer to 1 may be interpreted as the diffusion model has very high confidence in the corresponding prediction. The diffusion model training module 130 may train the diffusion model with different loss functions according to a plurality of loss function introduction modes, taking into account a specific purpose or environment.

In some example embodiments, in the first loss function introduction mode, the loss function may be determined according to Equation 1 below.

$$L = Mean ( {L}^{*} ) , L ∈ R \qquad ( Equation 1 )$$

Herein, L is a loss function, Mean( ) is a function that computes a mean, R is a set of real numbers, and L* may be determined according to Equation 2 below.

$${L}^{*} = {C}_{d c} ⊙ \sqrt{{( G T D D M - P D D M )}^{2}} , {L}^{*} ∈ {R}^{D \times H \times W} \qquad ( Equation 2 )$$

Herein, C_{dc} is the confidence, the operator ⊙ is the pixel wise dot product operator, and GTDDM (Ground Truth Dense Depth Map) is an actual true answer for the dense depth map, PDDM (Predicted Dense Depth Map) is a predicted value for the dense depth map, and R^{D×H×W} may be a set of real numbers (wherein D is the number of channels of the dense depth map, H is the vertical length of the dense depth map, and W is the horizontal length of the dense depth map).

The confidence C_{dc} may be determined according to Equation 3 and Equation 4 below.

$${C}_{dc}^{*} = C + {C}_{e} \qquad ( Equation 3 )$$

$${C}_{dc} = \{ \begin{matrix}{C}_{dc}^{*} , ( if {C}_{dc}^{*} > 0 ) \\ 1 , ( Otherwise )\end{matrix} \qquad ( Equation 4 )$$

Herein, C is the difference between the output value and the answer in the diffusion model, and Cₑ may be determined according to Equation 5 and Equation 6 below.

$${C}_{e} = C ⊙ {E}^{*} \qquad ( Equation 5 )$$

$${E}^{*} = \{ \begin{matrix}w * E ( if Sobel ( PDDM ) > γ , w > 1 ) \\ 0 , ( Otherwise )\end{matrix} \qquad ( Equation 6 )$$

Herein, E is an edge map acquired by passing through an edge detector, Sobel( ) is a function for detecting an edge intensity in the edge map, γ may be a predetermined reference value, and w may be a predetermined weight. Sobel( ) may detect the boundary of an image by calculating the gradient of the pixel values contained in the image.

C may be determined according to Equation 7 and Equation 8 below.

$${C}^{*} = \sqrt{{( G T D D M - P D D M )}^{2}} , {C}^{*} ∈ {R}^{D \times H \times W} \qquad ( Equation 7 )$$

$$C = \{ \begin{matrix}α ( if {C}^{*} > Mean ( {C}^{*} ) and GTDDM > 0 , α > 1 ) \\ 0 ( Otherwise )\end{matrix} \qquad ( Equation 8 )$$

Herein, α may be a predetermined weight. The diffusion model training module 130 may train the diffusion model by introducing the loss function in the first loss function introduction mode.

In some other example embodiments, in the second loss function introduction mode, the loss function may be determined according to Equation 9 below.

$$L = Mean ( {L}^{*} ) , L ∈ R \qquad ( Equation 9 )$$

Herein, L is the loss function, Mean( ) is the function that computes the mean, R is the set of real numbers, and L* may be determined according to Equation 10 below.

$${L}^{*} = C \vert GTDDM - PDDM \vert , {L}^{*} ∈ {R}^{D \times H \times W} \qquad ( Equation 10 )$$

Herein, GTDDM is an actual true answer for the dense depth map, PDDM is a predicted value for the dense depth map, R^{D×H×W} is a set of real numbers (wherein D is a number of channels of the dense depth map, H is a vertical length of the dense depth map, W is a horizontal length of the dense depth map), and C may be determined according to Equation 11 and Equation 12 below.

$${C}^{*} = \vert GTDDM - PDDM \vert , {C}^{*} ∈ {R}^{D \times H \times W} \qquad ( Equation 11 )$$

$$C = \{ \begin{matrix}α ( if {C}^{*} > Mean ( {C}^{*} ) and GTDDM > 0 , α > 1 ) \\ 0 , ( Otherwise )\end{matrix} \qquad ( Equation 12 )$$

Herein, α may be a predetermined weight. The diffusion model training module 130 may train the diffusion model by introducing the loss function in the second loss function introduction mode.

In some other example embodiments, in the third loss function introduction mode, the loss function may be determined according to Equation 13 below.

$$L = Mean ( {L}^{*} ) , L ∈ R \qquad ( Equation 13 )$$

Herein, L is the loss function, Mean( ) is the function that computes a mean, R is the set of real numbers, and L* may be determined according to Equation 14 below.

$${L}^{*} = C ⊙ \sqrt{{( G T D D M - P D D M )}^{2}} , {L}^{*} ∈ {R}^{D \times H \times W} \qquad ( Equation 14 )$$

Herein, the operator ⊙ is a pixel wise dot product, GTDDM is an actual true answer for the dense depth map, PDDM is a predicted value for the dense depth map, R^{D×H×W} is a set of real numbers (wherein D is a number of channels of the dense depth map, H is a vertical length of the dense depth map, and W is a horizontal length of the dense depth map), and C may be determined according to Equation 15 and Equation 16 below.

$${C}^{*} = \sqrt{{( G T D D M - P D D M )}^{2}} , {C}^{*} ∈ {R}^{D \times H \times W} \qquad ( Equation 15 )$$

$$C = \{ \begin{matrix}α ( if {C}^{*} > Mean ( {C}^{*} ) and GTDDM > 0 , α > 1 ) \\ 0 ( Otherwise )\end{matrix} \qquad ( Equation 16 )$$

Herein, α may be a predetermined weight. The diffusion model training module 130 may train the diffusion model by introducing the loss function in the third loss function introduction mode.

In some other example embodiments, in the fourth loss function introduction mode, the loss function may be determined according to Equation 17 below.

$$L = Mean ( {L}^{*} ) , L ∈ R \qquad ( Equation 17 )$$

Herein, L is a loss function, Mean( ) is a function that computes a mean, R is a set of real numbers, and L* may be determined according to Equation 18 below.

$${L}^{*} = {E}^{*} ⊙ \sqrt{{( GTDDM - PDDM )}^{2} ,} {L}^{*} ∈ {R}^{D \times H \times W} \qquad ( Equation 18 )$$

Herein, the operator ⊙ is a pixel wise dot product, GTDDM is an actual true answer for the dense depth map, PDDM is a predicted value for the dense depth map, R^{D×H×W} is a set of real numbers (wherein D is a number of channels of the dense depth map, H is a vertical length of the dense depth map, and W is a horizontal length of the dense depth map), and E* may be determined according to Equation 19 below.

$${E}^{*} = \{ \begin{matrix}w * E ( if Sobel ( PDDM ) > γ , w > 1 ) \\ 0 , ( Otherwise )\end{matrix} \qquad ( Equation 19 )$$

Herein, E is an edge map acquired by passing the edge detector, Sobel( ) is a function that detects edge intensity in the edge map, γ is a predetermined reference value, and w may be a predetermined weight. The diffusion model training module 130 may train the diffusion model by introducing the loss function in the fourth loss function introduction mode.

In this way, the depth map generation device may determine different performance paths according to the setting (e.g., a combination of one of the first setting and the second setting and one of the first loss function introduction mode to the fourth loss function introduction mode) predetermined by reflecting and considering the specific implementation purpose and environment, and train the diffusion model according to the determined performance path, thereby improving the prediction quality and accuracy appropriate to the situation. For example, for human-robot interaction, for general object detection and tracking, for scene understanding, and for robot navigation, different settings may be applied to implement appropriate depth map generation, taking into account the performance required and computing resources consumed in each situation.

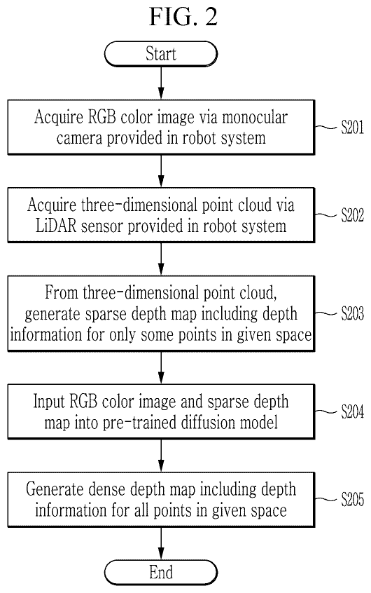

FIG. 2 is a flow diagram for illustrating a depth map generation method according to an example embodiment.

Referring to FIG. 2, a depth map generation method according to an example embodiment may include: acquiring an RGB color image via a monocular camera provided in a robot system (S201); acquiring a three-dimensional point cloud via a LiDAR sensor provided in the robot system (S202); from the three-dimensional point cloud, generating a sparse depth map including depth information for only some points in the given space (S203); inputting the RGB color image and the sparse depth map into a pre-trained diffusion model (S204); and generating a dense depth map including depth information for all points in the given space (S205). For further details of the above methods, reference may be made to or adapted from the description of the example embodiments described herein, so that duplicative descriptions are omitted herein.

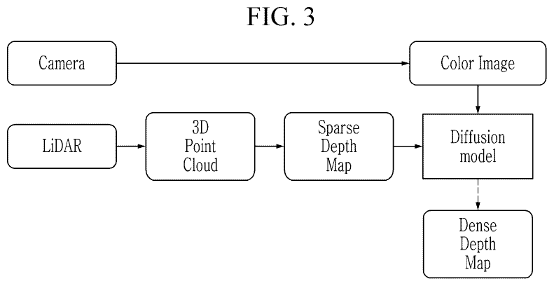

FIG. 3 is a flow diagram for illustrating the depth map generation method according to the example embodiment.

Referring to FIG. 3, a depth map generation method according to an example embodiment may provide a color image acquired from a camera as a first input to a diffusion model, and provide a sparse depth map generated from a three-dimensional point cloud acquired via a LiDAR sensor as a second input to the diffusion model.

The diffusion model may perform a diffusion process that gradually corrupts the real data with noise, as described above, and an inverse process or inverse diffusion process that recovers the original data from the noise. Training of a diffusion model may be performed by leading the neural network to make increasingly accurate predictions by focusing on accurately modeling the amount of noise that the neural network needs to predict at a specific time step, minimizing losses, to eventually allow the neural network to mimic the actual data distribution.

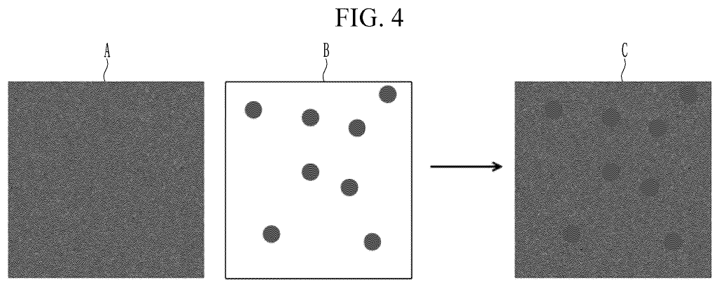

FIG. 4 is a diagram for illustrating an example of an operation of the depth map generation device according to the example embodiment.

Referring to FIG. 4, an example of an operation in which the diffusion model training module 130 replaces values of noise A with other values to generate noise C with some values replaced may be understood. In a sparse depth map B acquired from the LiDAR sensor, one or more local regions may be set, as indicated by the circles. Each of the one or more set local regions is assigned a sparse depth value, and the noise value of a location in the noise A corresponding to the one or more local regions in the sparse depth map B may be replaced with the corresponding sparse depth value. A diffusion model trained based on the noise C in which the values of the locations corresponding to the one or more local regions have been replaced, and the sparse depth map B on which the normalization has been performed, may predict more accurate dense depth values. In some example embodiments, the local region may be a single pixel with a depth value acquired from a LiDAR sensor.

In some embodiments, the noise C may be generated according to the Equation 20 below.

$$\begin{matrix}{m}_{j} = \{ \begin{matrix}1 , if value of {d}_{s} exists \\ 0 , otherwise\end{matrix} , \\ {SDN}_{t} = m ⊙ {d}_{s} + ( 1 - m ) ⊙ {z}_{t}\end{matrix} \qquad ( Equation 20 )$$

In the equation, dₛ may represent the value of a local region, such as the one indicated by a circle. The sparse depth map B may include nonzero positive real values in the local region and zero values in the remaining regions. Therefore, mⱼ may function as a mask that indicates the position of pixels where nonzero values exist in the sparse depth map B.

Since SDNₜ, which defines the noise C, is a diffusion model that operates through multiple iterations, t represents a specific iteration, and zₜ may represent random noise at that iteration. Accordingly, SDN may refer to noise in which specific pixels (i.e., pixels where nonzero values exist in the sparse depth map B) are replaced with the values of the sparse depth map B within the random noise. Here, the ⊙ operator may be a pixel wise dot product.

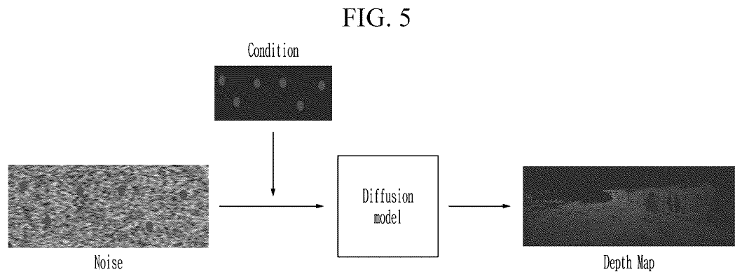

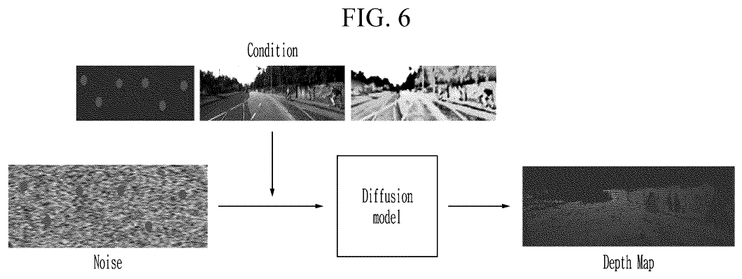

FIG. 5 is a diagram for illustrating an example of an operation of the depth map generation device according to the example embodiment, and FIG. 6 is a diagram for illustrating an example of an operation of the depth map generation device according to the example embodiment.

The diffusion model training module 130 may determine, as an input to the diffusion model, conditions to be assigned with the noise, concatenate the determined conditions with the noise, and train the diffusion model based on the condition concatenated with the noise. The conditions may include any one of a first condition to a fifth condition, and a first condition includes a sparse depth map, a second condition includes an RGB color image and a sparse depth map, a third condition includes an RGB color image, an edge image, and a sparse depth map, a fourth condition includes a gray image and a sparse depth map, and a fifth condition includes a gray image, an edge image, and a sparse depth map.

Referring to FIG. 5, the diffusion model training module 130 may train a diffusion model based on an input in which the first condition conditioned on a sparse depth map alone is concatenated with noise. Herein, the sparse depth map may correspond to the sparse depth map B in FIG. 4, and the noise may correspond to the noise C in which the values of the locations corresponding to one or more local regions are replaced in FIG. 4.

Referring to FIG. 6, the diffusion model training module 130 may train a diffusion model based on the input in which the third condition conditioned on the RGB color image, the edge image, and the sparse depth map is concatenated with noise.

After trying each condition, the depth map generation device may determine a condition that provides results with a high degree of similarity to the answer and train the diffusion model by using the determined condition. By determining the conditions optimal for specific implementation purposes and environments through the trial and evaluation of the multiple conditions and performing training based on those conditions, it is possible to improve prediction quality and accuracy.

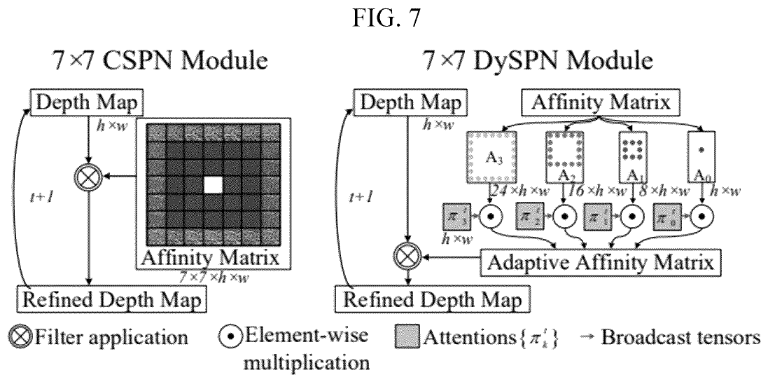

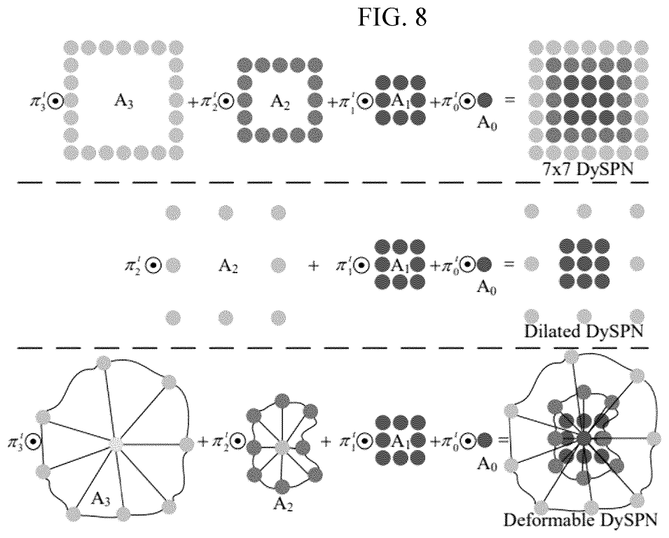

FIG. 7 and FIG. 8 are diagrams for illustrating an example of an operation of the depth map generation device according to the example embodiment.

Referring to FIGS. 7 and 8, in the process of improving depth information based on sparse depth information, the sparse depth information may be propagated to neighboring pixels to estimate depth values for regions where sparse depth values do not exist. To improve this propagation of depth information to be more flexible and effective, the depth map generation device according to the example embodiment may perform a computation based on a Dynamic Spatial Propagation Network (DySPN) to adjust pixel locations to emphasize important parts of the input feature map via deformable convolution. In this way, when the information is propagated from a pixel with sparse depth information to its surroundings, the depth map generation device may propagate depth information while dynamically adjusting a relationship with neighboring pixels, so that the initial depth map may be improved to a more accurate depth map.

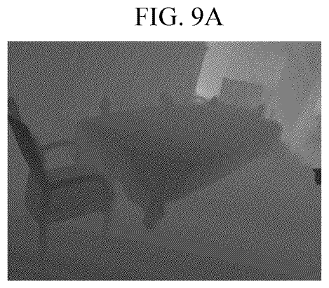

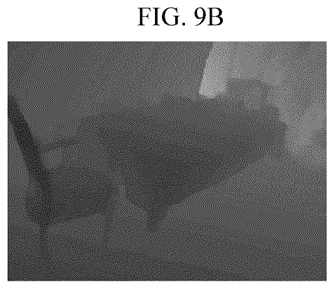

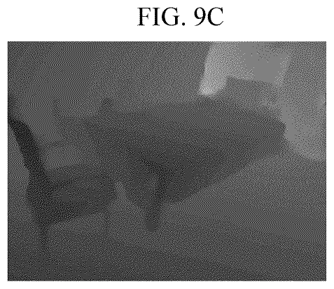

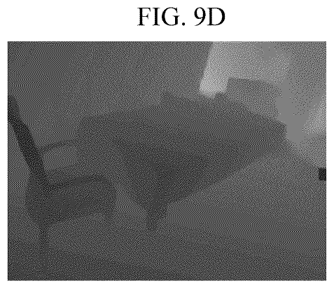

FIG. 9A, FIG. 9B, FIG. 9C and FIG. 9D are diagrams illustrating example dense depth maps generated according to the example embodiments.

Referring to FIG. 9A, FIG. 9B, FIG. 9C and FIG. 9D, FIG. 9A represents a ground truth image, and FIG. 9B is an image generated by a conventional diffusion model, FIG. 9C an image generated by a diffusion model trained with the noise in which values of locations corresponding to the one or more local regions are replaced with sparse depth values of the one or more local regions, according to the first setting, FIG. 9D is an image generated by a diffusion model trained with noise according to the first setting, and with a loss function that introduces a confidence according to a first loss function introduction mode. The Root Mean Square Error (RMSE) is 218.04 for FIG. 9B, 209.04 for FIG. 9C, and 200.83 for FIG. 9D, and it may be understood that FIG. 9D predicts the dense depth map most accurately.

FIG. 10 is a diagram for illustrating a computing device according to an example embodiment.

Referring now to FIG. 10, the depth map generation method and device according to the example embodiments may be implemented by using a computing device 50. The computing device 50 may be implemented as various forms of electronic devices, servers, or similar devices, and their functionality may be realized through a combination of software and hardware.

The computing device 50 may include at least one of a processor 510, a memory 530, a user interface input device 540, a user interface output device 550, and a storage device 560 communicating via a bus 520. The computing device 50 may also include a network interface 570 electrically connected to the network 40. The network interface 570 may transmit or receive a signal with another entity through the network 40.

The processor 510 may be implemented as various types of computing devices, such as a microcontroller unit (MCU), application processor (AP), central processing unit (CPU), graphic processing unit (GPU), neural processing unit (NPU), quantum processing unit (QPU), and the like. The processor 510 is also a semiconductor device that executes instructions stored in the memory 530 or storage device 560, and may play a key role in the system. Program code and data stored in memory 530 or storage device 560 directs processor 510 to perform specific tasks, which in turn enables system-wide operation. The processor 510 may be configured to implement the various functions and methods described above with reference to FIGS. 1 to 9.

The memory 530 and the storage device 560 may include various forms of volatile or non-volatile storage media for data storage and access of the system. For example, the memory 530 may include a read only memory (ROM) 531 and a random access memory (RAM) 532. In some example embodiments, the memory 530 may be embedded inside the processor 510, in which case data transmission between the memory 530 and the processor 510 may be very fast. In some other example embodiments, the memory 530 may be located external to the processor 510, in which case the memory 530 may be coupled to the processor 510 via various data buses or interfaces. The connections may be made through various already known means, for example, through the Peripheral Component Interconnect Express (PCIe) interface for high-speed data transfer or through the memory controller.

In some example embodiments, at least some configurations or functions of the depth map generation method and device according to the example embodiments may be implemented as programs or software executed on the computing device 50, and the programs or software may be stored on a computer-readable medium. Specifically, a computer-readable medium according to the example embodiment may record a program for executing the operations included in an implementation of the depth map generation method and device according to the example embodiments on a computer including the processor 510 executing a program or instructions stored in the memory 530 or the storage device 560.

In some example embodiments, at least some configurations or features of the depth map generation method and device according to the example embodiments may be implemented using hardware or circuit of the computing device 50, or may be implemented as separate hardware or circuit that may be electrically connected to computing device 50.

According to the example embodiments, a sparse depth map may be generated by using data acquired from a LiDAR sensor and a monocular camera provided on the robot system, and a sophisticated dense depth map may be generated by using a diffusion model. As a result, a sufficient amount of depth information may be acquired from sparse depth maps that have the amount of information insufficient for human interaction or driving. Furthermore, discrete depth maps corresponding to similar answers and continuous depth maps corresponding to the final answer may be acquired by using the diffusion model. Furthermore, the accuracy of the dense depth maps generated from the diffusion model may be improved by introducing noise and loss functions that are designed specifically for robot systems.

Although the above example embodiments of the present invention have been described in detail, the scope of the present invention is not limited thereto, but also includes various modifications and improvements by one of ordinary skill in the art utilizing the basic concepts of the present invention as defined in the following claims.

What is claimed is:

1. A method of generating a depth map, the method comprising:
acquiring an RGB color image via a monocular camera provided in a robot system;
acquiring a three-dimensional point cloud via a light detection and ranging (LiDAR) sensor provided in the robot system;
generating, from the three-dimensional point cloud, a sparse depth map including first depth information for only some points in a particular space;
inputting the RGB color image and the sparse depth map into a pre-trained diffusion model; and
generating, based on the pre-trained diffusion model, a dense depth map including second depth information for all points in the particular space,
wherein:
the pre-trained diffusion model is trained by introducing a loss function that reflects confidence, and
the confidence is a numerical representation of a confidence level in a prediction of the pre-trained diffusion model.

2. The method of claim 1, further comprising:
training the pre-trained diffusion model to predict the dense depth map when noise and the sparse depth map are input, by using the noise and the sparse depth map as training data according to a predetermined setting.

3. The method of claim 2, wherein the training of the pre-trained diffusion model includes:
reading the predetermined setting;
when it is determined that the predetermined setting includes a first setting, normalizing a depth value of the sparse depth map to a value in a range of −1 to 1;
setting one or more local regions in the sparse depth map;
replacing, in the noise, a value of a location corresponding to the one or more local regions with a sparse depth value in the one or more local regions; and
training the pre-trained diffusion model based on the noise, in which the value of the location corresponding to the one or more local regions is replaced, and the sparse depth map in which the normalization has been performed.

4. The method of claim 2, wherein the training of the pre-trained diffusion model includes:
reading the predetermined setting;
when it is determined that the predetermined setting includes a second setting, normalizing a depth value of the sparse depth map used as the training data to a value in a range of −1 to 1; and
training the pre-trained diffusion model based on the noise and the sparse depth map on which the normalization has been performed.

5. The method of claim 1, wherein:
the loss function is determined by Equation 1 below,
$$L = Mean ( {L}^{*} ) , L ∈ R \qquad ( Equation 1 )$$
in which L is the loss function, Mean( ) is a function that computes a mean, R is a set of real numbers, and L* is determined according to Equation 2 below:
$${L}^{*} = {C}_{d c ⊙ \sqrt{{( GTDDM - PDDM )}^{2} ,}} {L}^{*} ∈ {R}^{D \times H \times W} \qquad ( Equation 2 )$$
in which Cdc is the confidence, an operator ⊙ is a pixel wise dot product operator, and GTDDM (Ground Truth Dense Depth Map) is an actual true answer for the dense depth map, PDDM (Predicted Dense Depth Map) is a predicted value for the dense depth map, and R^{D×H×W} is a set of real numbers in which D is a number of channels of the dense depth map, H is a vertical length of the dense depth map, and W is a horizontal length of the dense depth map.

6. The method of claim 5, wherein:
the confidence C_{dc} is determined according to Equation 3 and Equation 4 below;
$${C}_{d c}^{*} = C + {C}_{e} \qquad ( Equation 3 )$$
$${C}_{d c} = \{ \begin{matrix}{C}_{d c}^{*} , ( if {C}_{d c}^{*} > 0 ) \\ 1 , ( Otherwise )\end{matrix} \qquad ( Equation 4 )$$
in which C is a difference between an output value and an answer in the pre-trained diffusion model, and Cₑ is determined according to Equation 5 and Equation 6 below:
$${C}_{e} = C ⊙ {E}^{*} \qquad ( Equation 5 )$$
$${E}^{*} = \{ \begin{matrix}w * E ( if Sobel ( PDDM ) > γ , w > 1 ) \\ 0 , ( Otherwise )\end{matrix} \qquad ( Equation 6 )$$
in which E is an edge map acquired by passing through an edge detector, Sobel( ) is a function for detecting an edge intensity in the edge map, γ is a predetermined reference value, and w is a predetermined weight.

7. The method of claim 6, wherein:
the C is determined according to Equation 7 and Equation 8 below;
$${C}^{*} = \sqrt{{( GTDDM - PDDM )}^{2} ,} {C}^{*} ∈ {R}^{D \times H \times W} \qquad ( Equation 7 )$$
$$C = \{ \begin{matrix}α ( if {C}^{*} > Mean ( {C}^{*} ) and GTDDM > 0 \& , α > 1 ) \\ 0 ( Otherwise )\end{matrix} \qquad ( Equation 8 )$$
in which α is a predetermined weight.

8. The method of claim 1, wherein:
the loss function is determined according to Equation 9 below:
$$L = Mean ( {L}^{*} ) , L ∈ R \qquad ( Equation 9 )$$
in which L is the loss function, Mean( ) is the function that computes the mean, R is the set of real numbers, and L* is determined according to Equation 10 below:
$${L}^{*} = C \vert GTDDM - PDDM \vert , {L}^{*} ∈ {R}^{D \times H \times W} \qquad ( Equation 10 )$$
in which GTDDM is an actual true answer for the dense depth map, PDDM is a predicted value for the dense depth map, R^{D×H×W} is a set of real numbers in which D is a number of channels of the dense depth map, H is a vertical length of the dense depth map, W is a horizontal length of the dense depth map, and C is determined according to Equation 11 and Equation 12 below:
$${C}^{*} = \vert GTDDM - PDDM \vert , {C}^{*} ∈ {R}^{D \times H \times W} \qquad ( Equation 11 )$$
$$C = \{ \begin{matrix}α ( if {C}^{*} > Mean ( {C}^{*} ) and GTDDM > 0 \& , α > 1 ) \\ 0 ( Otherwise )\end{matrix} \qquad ( Equation 12 )$$
in which α is a predetermined weight.

9. The method of claim 1, wherein:
the loss function is determined according to Equation 13 below:
L=Mean(L*),L∈R (Equation 13)
in which L is the loss function, Mean( ) is the function that computes a mean, R is the set of real numbers, and L* is determined according to Equation 14 below:
$${L}^{*} = C ⊙ \sqrt{{( G T D D M - P D D M )}^{2} ,} {L}^{*} ∈ {R}^{D \times H \times W} \qquad ( Equation 14 )$$
in which the operator ⊙ is a pixel wise dot product, GTDDM is an actual true answer for the dense depth map, PDDM is a predicted value for the dense depth map, R^{D×H×W} is a set of real numbers in which D is a number of channels of the dense depth map, H is a vertical length of the dense depth map, and W is a horizontal length of the dense depth map, and C is determined according to Equation 15 and Equation 16 below:
$${C}^{*} = \sqrt{{( GTDDM - PDDM )}^{2} ,} {C}^{*} ∈ {R}^{D \times H \times W} \qquad ( Equation 15 )$$
$$C = \{ \begin{matrix}α ( if {C}^{*} > Mean ( {C}^{*} ) and GTDDM > 0 \& , α > 1 ) \\ 0 ( Otherwise )\end{matrix} \qquad ( Equation 16 )$$
in which α is a predetermined weight.

10. The method of claim 1, wherein:
the loss function is determined according to Equation 17 below:
$$L = Mean ( {L}^{*} ) , L ∈ R \qquad ( Equation 17 )$$
in which L is the loss function, Mean( ) is a function that computes a mean, R is a set of real numbers, and L* is determined according to Equation 18 below,
$${L}^{*} = {E}^{* ⊙ \sqrt{{( GTDDM - PDDM )}^{2} ,}} {L}^{*} ∈ {R}^{D \times H \times W} \qquad ( Equation 18 )$$
herein, the operator ⊙ is a pixel wise dot product, GTDDM is an actual true answer for the dense depth map, PDDM is a predicted value for the dense depth map, R^{D×H×W} is a set of real numbers in which D is a number of channels of the dense depth map, H is a vertical length of the dense depth map, and W is a horizontal length of the dense depth map, and E* is determined according to Equation 19 below:
$${E}^{*} = \{ \begin{matrix}w * E ( if Sobel ( PDDM ) > γ , w > 1 ) \\ 0 , ( Otherwise )\end{matrix} \qquad ( Equation 19 )$$
in which E is an edge map acquired by passing an edge detector, Sobel( ) is a function that detects edge intensity in the edge map, γ is a predetermined reference value, and w is a predetermined weight.

11. A device for generating a depth map, comprising:
one or more processors; and
one or more memory devices storing program code which, when executed by the one or more processors, causes the one or more processors to:
acquire an RGB color image via a monocular camera provided in a robot system;
acquire a three-dimensional point cloud via a light detection and ranging (LiDAR) sensor provided in the robot system;
generate, from the three-dimensional point cloud, a sparse depth map including first depth information for only some points in a particular space;
input the RGB color image and the sparse depth map into a pre-trained diffusion model; and
generate, based on the diffusion model, a dense depth map including second depth information for all points in the particular space,
wherein:
the pre-trained diffusion model is trained by introducing a loss function that reflects confidence, and
the confidence is a numerical representation of confidence level in a prediction of the pre-trained diffusion model.

12. The device of claim 11, wherein the execution of the program code by the one or more processors further causes the one or more processors to:
train the pre-trained diffusion model to predict the dense depth map when noise and the sparse depth map are input, by using the noise and the sparse depth map as training data according to a predetermined setting.

13. The device of claim 12, wherein, to train the pre-trained diffusion model, the execution of the program code by the one or more processors further causes the one or more processors to:
read the predetermined setting;
when it is determined that the predetermined setting includes a first setting, normalize a depth value of the sparse depth map to a value in a range of −1 to 1;
set one or more local regions in the sparse depth map;
replace, in the noise, a value of a location corresponding to the one or more local regions with a sparse depth value in the one or more local regions; and
train the pre-trained diffusion model based on the noise, in which the value of the location corresponding to the one or more local regions is replaced, and the sparse depth map in which the normalization has been performed.

14. The device of claim 12, wherein, to train the pre-trained diffusion model, the execution of the program code by the one or more processors further causes the one or more processors to:
read the predetermined setting;
when it is determined that the predetermined setting includes a second setting, normalize a depth value of the sparse depth map used as the training data to a value in a range of −1 to 1; and
train the pre-trained diffusion model based on the noise and the sparse depth map on which the normalization has been performed.

15. The device of claim 11, wherein:
the loss function is determined by Equation 1 below,
$$L = Mean ( {L}^{*} ) , L ∈ R \qquad ( Equation 1 )$$
in which L is the loss function, Mean( ) is a function that computes a mean, R is a set of real numbers, and L* is determined according to Equation 2 below:
$${L}^{*} = {C}_{dc ⊙ \sqrt{{( GTDDM - PDDM )}^{2} ,}} {L}^{*} ∈ {R}^{D \times H \times W} \qquad ( Equation 2 )$$
herein, Cdc is the confidence, an operator ⊙ is a pixel wise dot product operator, and GTDDM (Ground Truth Dense Depth Map) is an actual true answer for the dense depth map, PDDM (Predicted Dense Depth Map) is a predicted value for the dense depth map, and R^{D×H×W} is a set of real numbers in which D is a number of channels of the dense depth map, H is a vertical length of the dense depth map, and W is a horizontal length of the dense depth map.

16. The device of claim 15, wherein:
the confidence Cdc is determined according to Equation 3 and Equation 4 below;
$${C}_{d c}^{*} = C + {C}_{e} \qquad ( Equation 3 )$$
$${C}_{d c} = \{ \begin{matrix}{C}_{dc}^{*} , ( if {C}_{d c}^{*} > 0 ) \\ 1 , ( Otherwise )\end{matrix} \qquad ( Equation 4 )$$
in which C is a difference between an output value and an answer in the pre-trained diffusion model, and Ce is determined according to Equation 5 and Equation 6 below:
$${C}_{e} = C ⊙ {E}^{*} \qquad ( Equation 5 )$$
$${E}^{*} = \{ \begin{matrix}w * E ( if Sobel ( PDDM ) > γ , w > 1 ) \\ 0 , ( Otherwise )\end{matrix} \qquad ( Equation 6 )$$
in which E is an edge map acquired by passing through an edge detector, Sobel( ) is a function for detecting an edge intensity in the edge map, γ is a predetermined reference value, and w is a predetermined weight.

17. The device of claim 16, wherein:
the C is determined according to Equation 7 and Equation 8 below;
$${C}^{*} = \sqrt{{( G T D D M - P D D M )}^{2}} , {C}^{*} ∈ {R}^{D \times H \times W} \qquad ( Equation 7 )$$
$$C = \{ \begin{matrix}α ( if {C}^{*} > Mean ( {C}^{*} ) and GTDDM > 0 \& , α > 1 \\ 0 ( Otherwise )\end{matrix} \qquad ( Equation 8 )$$
in which α is a predetermined weight.

18. The device of claim 11, wherein:
the loss function is determined according to Equation 9 below:
$$L = Mean ( {L}^{*} ) , L ∈ R \qquad ( Equation 9 )$$
in which L is the loss function, Mean( ) is the function that computes the mean, R is the set of real numbers, and L* is determined according to Equation 10 below:
$${L}^{*} = C \vert GTDDM - PDDM \vert , {L}^{*} ∈ {R}^{D \times H \times W} \qquad ( Equation 10 )$$
in which GTDDM is an actual true answer for the dense depth map, PDDM is a predicted value for the dense depth map, R^{D×H×W} is a set of real numbers in which D is a number of channels of the dense depth map, H is a vertical length of the dense depth map, W is a horizontal length of the dense depth map), and C is determined according to Equation 11 and Equation 12 below:
$${C}^{*} = \vert GTDDM - PDDM \vert , {C}^{*} ∈ {R}^{D \times H \times W} \qquad ( Equation 11 )$$
$$C = \{ \begin{matrix}α ( if {C}^{*} > Mean ( {C}^{*} ) and GTDDM > 0 \& , α > 1 ) \\ 0 ( Otherwise )\end{matrix} \qquad ( Equation 12 )$$
in which α is a predetermined weight.

19. The device of claim 11, wherein:
the loss function is determined according to Equation 13 below:
$$L = Mean ( {L}^{*} ) , L ∈ R \qquad ( Equation 13 )$$
in which L is the loss function, Mean( ) is the function that computes a mean, R is the set of real numbers, and L* is determined according to Equation 14 below:
$${L}^{*} = C ⊙ \sqrt{{( G T D D M - P D D M )}^{2}} , {L}^{*} ∈ {R}^{D \times H \times W} \qquad ( Equation 14 )$$
in which the operator ⊙ is a pixel wise dot product, GTDDM is an actual true answer for the dense depth map, PDDM is a predicted value for the dense depth map, R^{D×H×W} is a set of real numbers in which D is a number of channels of the dense depth map, H is a vertical length of the dense depth map, and W is a horizontal length of the dense depth map, and C is determined according to Equation 15 and Equation 16 below:
$${C}^{*} = \sqrt{{( G T D D M - P D D M )}^{2}} , {C}^{*} ∈ {R}^{D \times H \times W} \qquad ( Equation 15 )$$
$$C = \{ \begin{matrix}α ( if {C}^{*} > Mean ( {C}^{*} ) and GTDDM > 0 \& , α > 1 ) \\ 0 ( Otherwise )\end{matrix} \qquad ( Equation 16 )$$
in which α is a predetermined weight.

20. The device of claim 11, wherein:
the loss function is determined according to Equation 17 below:
$$L = Mean ( {L}^{*} ) , L ∈ R \qquad ( Equation 17 )$$
in which L is the loss function, Mean( ) is a function that computes a mean, R is a set of real numbers, and L* is determined according to Equation 18 below,
$${L}^{*} = {E}^{* ⊙ \sqrt{{( GTDDM - PDDM )}^{2} ,}} {L}^{*} ∈ {R}^{D \times H \times W} \qquad ( Equation 18 )$$
in which the operator ⊙ is a pixel wise dot product, GTDDM is an actual true answer for the dense depth map, PDDM is a predicted value for the dense depth map, R^{D×H×W} is a set of real numbers in which D is a number of channels of the dense depth map, H is a vertical length of the dense depth map, and W is a horizontal length of the dense depth map, and E* is determined according to Equation 19 below:
$${E}^{*} = \{ \begin{matrix}w * E ( if Sobel ( PDDM ) > γ , w > 1 ) \\ 0 , ( Otherwise )\end{matrix} \qquad ( Equation 19 )$$
in which E is an edge map acquired by passing an edge detector, Sobel( ) is a function that detects edge intensity in the edge map, γ is a predetermined reference value, and w is a predetermined weight.
